(19) United States
(12) Patent Application Publication
(10) Pub. No.: US 2004/0089007 A1
(43) Pub. Date: May 13, 2004

(54) Ceiling air-blowing device for a vehicle air conditioner

(76) Inventors: Makoto Umebayashi, Chiryu-city (JP); Tomohiro Inada, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/701,320

(22) Filed: Nov. 4, 2003

(30) Foreign Application Priority Data
Nov. 6, 2002 (JP) 2002-322666

(51) Int. Cl. B60H 1/00; B60H 1/26; B60H 1/32

(52) U.S. Cl. 62/244; 454/137

(57) ABSTRACT

In a ceiling air-blowing device for a vehicle air conditioner, a ceiling wall is disposed along a vehicle ceiling portion to define an air passage so that air from an air conditioner unit is introduced into the air passage through a pillar duct. The ceiling wall is formed with a plurality of holes having openings on a lower surface of the ceiling wall, so that the air in the air passage is blown off into the passenger compartment through the holes. Further, the holes are formed such that a total area of the openings of the holes per unit area at a position that is proximate to the end of the duct is smaller than that at a second position that is farther from the end of the duct than the first position. Therefore, the air is uniformly blown into the passenger compartment over a wide range of the ceiling.

### CROSS REFERENCE TO RELATED APPLICATION

This application is based on Japanese Patent Application No. 2002-322666 filed on Nov. 6, 2002, the disclosure of which is incorporated herein by reference.

### FIELD OF THE INVENTION

The present invention relates to a ceiling air-blowing device for a vehicle air conditioner, which produces flow of air from holes formed on a ceiling of a vehicle for air-conditioning a passenger compartment.

### BACKGROUND OF THE INVENTION

With regard to a conventional ceiling air-blowing device for a vehicle air conditioner, a grille through which air is blown into a passenger compartment is provided at a part of a ceiling such as at a side, front portion or rear portion of the ceiling. Thus, air is partly blown toward a passenger.

When a cooling load is high, since a cool air is blown from the part of the ceiling, a cold feeling is maintained. When the cooling load is low, however, the cool air that is partly blown from the ceiling causes passenger discomfort. Further, because this structure causes variations of flow velocity and temperature, it is difficult to provide an air-conditioning that the passenger feels comfort.

As another example of the ceiling air-blowing device, in JP-U-62-3310, a plurality of holes are formed on a ceiling of the vehicle and air is blown from the holes into the passenger compartment. A first plate is attached on an inner face of the ceiling and a second plate is arranged with a predetermined clearance from the first plate so that a closed air passage is defined between the first plate and the second plate. The plurality of holes are formed on the second plate. Conditioning air from an air conditioner unit is introduced into the air passage through a duct and blown downwardly from the holes into the passenger compartment.

However, size of the holes and air blowing directions are not proposed in JP-U-62-3310. Thus, it is assumed that the size of the holes and the directions are uniform. In this case, flow velocity of air passing through the holes are different depending on the distance from the duct to the respective holes, due to pressure loss in the air passage and the like. Accordingly, it is difficult to provide an air-conditioning uniformly over a wide range of the passenger compartment.

### SUMMARY OF THE INVENTION

The present invention is made in view of the foregoing matter and it is an object of the present invention to provide air-conditioning that a passenger feels comfort.

It is another object of the present invention to provide a ceiling air-blowing device for a vehicle air conditioner capable of relatively uniformly blowing conditioning air from a wide region of a ceiling of the vehicle.

It is further another object of the present invention to provide a ceiling air-blowing device for a vehicle air conditioner capable of easily adjusting flow direction of air from a ceiling of the vehicle.

According to a first aspect of the present invention, a ceiling air-blowing device for a vehicle air conditioner that has an air conditioner unit for air-conditioning a compartment includes a duct and a ceiling wall. The duct is disposed to communicate with the air conditioning unit. The ceiling wall is disposed along a ceiling portion of the vehicle to define an air passage communicating with the duct for receiving the air. The ceiling wall is formed with a plurality of holes, and openings of the holes are formed on a lower surface of the ceiling wall so that the air flowing through the air passage is blown off into the compartment through the holes. Further, the holes are disposed such that a total area of the openings of the holes per unit area at a first position that is proximate to an end of the duct is smaller than that at a second position that is farther from the end of the duct than the first position.

Accordingly, even if pressure loss is caused in the air passage, a volume of air blown from the holes of the second position is larger than a volume of air blown from the holes of the first position. Therefore, the blowing of air from the holes of the second position is facilitated as compared with that of the first position. As a result, the air is relatively uniformly blown from a wide range of the ceiling portion.

According to a second aspect of the present invention, the holes of the ceiling wall are formed such that an axis of each hole is disposed so that a flow resistance of air decreases with a distance from the end of the duct.

Accordingly, since the air flow directions from the holes are varied in accordance with the distance from the end of the duct, the air can be relatively uniformly blown from a wide range of the ceiling portion even if the size of the holes are uniform. Therefore, it improves an air-conditioning that a passenger fells comfortable.

According to a third aspect of the present invention, a ceiling air-blowing device for a vehicle air conditioner having an air conditioning unit receives air from the air conditioner unit. The ceiling air-blowing device includes an air passage member disposed along a ceiling portion of the vehicle. The air passage member includes a first wall member defining a first air passage therein and a second wall member defining a second air passage therein. The first wall member and the second wall member form a plurality of holes so that the air from the air conditioner unit is introduced into the air passage and blown off into the compartment through the holes. The device further includes an air distributing means for switching air distribution to the first passage and the second passage. The holes are formed such that an axis of each hole of the first wall member and an axis of each hole of the second wall member are inclined different directions from each other.

Accordingly, the flow direction of the air is changed by switching air distribution to the first air passage and the second air passage by the air-distributing means.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic view of a vehicle viewed from the top for showing an arrangement of a ceiling air-blowing device for a vehicle air conditioner according to the first embodiment of the present invention;

FIG. 2 is a cross-sectional view of a part of the ceiling air-blowing device according to the first embodiment of the present invention;

FIG. 3 is a schematic plan view of a ceiling base member for showing an arrangement of air-blowing holes according to the first embodiment of the present invention;

FIG. 4 is a schematic diagram for explaining a distribution of flow velocity of air as a comparison example with the first embodiment;

FIG. 5 is a schematic plan view of a ceiling base member for showing an arrangement of air-blowing holes according to the second embodiment of the present invention;

FIG. 6 is a schematic plan view of a ceiling base member for showing an arrangement of air-blowing holes according to the third embodiment of the present invention;

FIG. 7 is a schematic plan view of a ceiling base member for showing an arrangement of air-blowing holes according to the fourth embodiment of the present invention;

FIG. 8A is a schematic plan view of a ceiling base member for showing arrangement of air-blowing holes according to the fifth embodiment of the present invention;

FIG. 8B is a schematic cross-sectional view of a part of the ceiling air-blowing device shown in FIG. 8A taken along line VIIIB-VIIIB;

FIG. 9 is a schematic cross-sectional view of a part of the ceiling air-blowing device according to the sixth embodiment of the present invention;

FIG. 10 is a schematic cross-sectional view of a part of the ceiling air-blowing device according to the seventh embodiment of the present invention;

FIG. 11A is a side view of a first ceiling duct disposed along a ceiling of a vehicle according to the eighth embodiment of the present invention;

FIG. 11B is a cross-sectional view of the first ceiling duct shown in FIG. 11A taken along line XIB-XIB;

FIG. 11C is an end view of the first ceiling duct shown in FIG. 11A;

FIG. 11D is a perspective view of the first ceiling duct shown in FIG. 11A;

FIG. 11E is a cross-sectional view of a second ceiling duct disposed along the ceiling of the vehicle according to the eighth embodiment of the present invention; and

FIG. 12 is a schematic diagram of the ceiling air-blowing device for showing an air circulation according to the eighth embodiment of the present invention.

### DETAILED DESCRIPTION OF EMBODIMENTS

Embodiments of the present invention will be described hereinafter with reference to the drawings. In the drawings, up and down, right and left, and front and rear arrows denote arrangement directions of respective parts with respect to a vehicle.

### First Embodiment

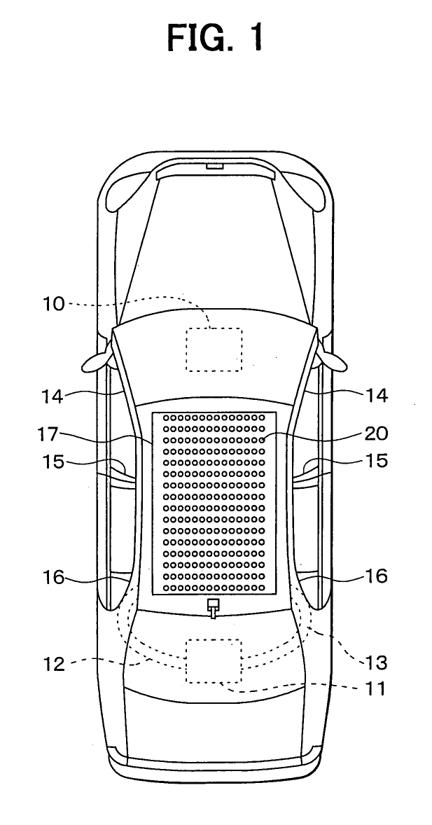

Referring to FIG. 1, a vehicle air conditioner includes a front air conditioner unit 10 and a rear air conditioner unit 11, as interior air conditioner units. The front air conditioner unit 10 is arranged in a space inside of an instrument panel, which is located at a very front position of a passenger compartment. The front air conditioner unit 10 air-conditions a front region of the passenger compartment. The rear air conditioner unit 11 is arranged under a luggage compartment lid, which is located at a very rear position of the passenger compartment. The rear air conditioner unit 11 air-conditions a rear region of the passenger compartment.

The front and rear air conditioner units 10, 11 have electric blowers, cooling heat exchangers for cooling air blown by the blowers, heating heat exchangers for heating the air, temperature setting devices for setting temperature of air blown into the passenger compartment, air blow mode switching devices, and the like, respectively. Thus, the front and rear air conditioner units 10, 11 independently adjust the temperature of air blown into the passenger compartment and the volumes of air blown by the blowers and switch air blow modes.

In the embodiment, a left pillar duct 12 and a right pillar duct 13 are connected to an air outlet portion of the rear air conditioner unit 11. The vehicle generally has front pillars 14, middle pillars 15 and the rear pillars 16. The left pillar duct 12 and the right pillar duct 13 are disposed to extend to a ceiling of the vehicle along the rear pillars 16 of the vehicle. Ends (top ends) of the left duct 12 and the right duct 13 are connected to a left end and a right end of a rear portion of an air passage 17 that is formed on the ceiling, respectively.

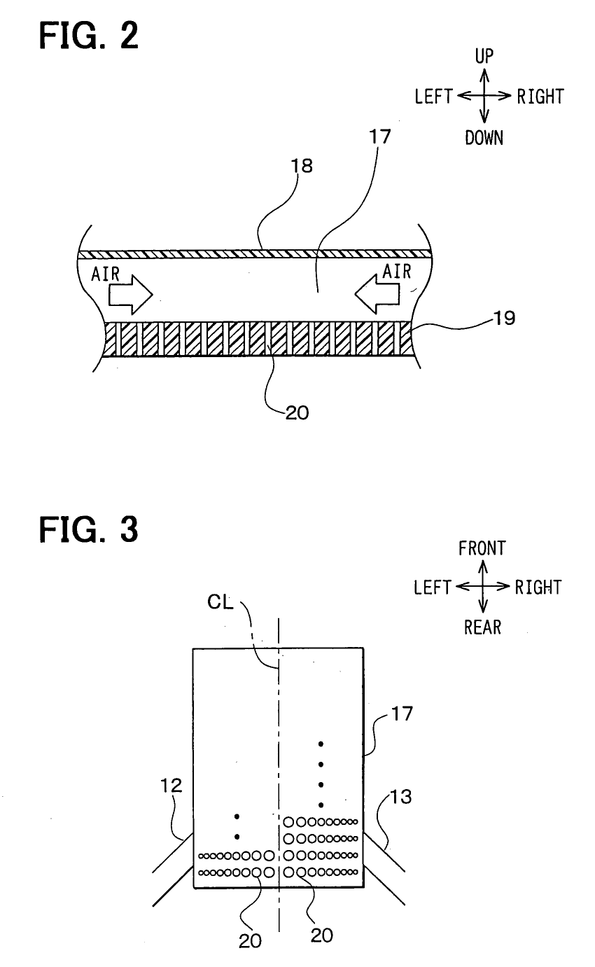

The air passage 17 is formed along a rectangular range extending in a vehicle front and rear direction substantially throughout the ceiling. Specifically, as shown in FIG. 2, the air passage 17 is formed between a heat insulation sheet member 18 and a ceiling base member (ceiling wall) 19. The heat insulation sheet member 18 is arranged on a rear face (inside face) of a roof (not shown In FIG. 2) of the vehicle. The heat insulation sheet member 18 is made of a resin material that provides heat insulation and sealing.

The ceiling base member 19 is arranged under the heat insulation sheet member 18. The ceiling base member 19 has a thickness greater than that of the heat insulation sheet member 18. The ceiling base member 19 is made of a resin material. The ceiling base member 19 provides a base of the ceiling of the vehicle. A predetermined clearance is formed between the heat insulation sheet member 18 and the ceiling base member 19 so that the air passage 17 is defined between them. Thus, the air passage 17 is formed in a substantially flat area along the ceiling. The ends of the pillar ducts 12, 13 are air-tightly connected to the air passage 17 by the sealing of the heat insulation sheet member 18.

The ceiling base member 19 is formed with a plurality of air-blowing outlets (holes, hereinafter) 20 through which conditioning air from the rear air conditioner unit 11 is blown downwardly into the passenger compartment. The holes 20 are formed into circular shapes, for example. As shown in FIG. 1, the holes 20 are formed substantially over a range where the air passage 17 is formed.

The air passage 17 is formed on the ceiling of the vehicle and the air is blown from the holes 20 toward the passenger's head. Therefore, the air passage 17 is mainly used for blowing cool air during a cooling operation where the temperature of air is adjusted at low temperature in the rear air conditioner unit 11.

Next, structure of the holes 20 will be described in detail with reference to FIG. 3.

The holes 20 are formed such that the area (size) of an opening of each hole 20, that is, a diameter of each hole 20,is small in a region that is proximate to the ends of the pillar ducts 12, 13, that is, a region where a distance from the pillar ducts 12, 13 is short. The area of the opening of each hole 20 increases with its distance from the end of the duct 12, 13.

More specifically, in FIG. 3, the area of the opening of each hole 20 increases with respect to the left and right direction of the ceiling. That is, the holes 20 at a right end and a left end of the ceiling base member 19, which are proximate to the ends of the pillar ducts 12, 13, are smallest. The size of the holes 20 gradually increases toward a middle position (longitudinal axis CL) of the ceiling base member 19 with respect to the right and left direction. Thus, the holes 20 that are proximate to the middle position are largest.

Accordingly, a total area of the openings of the holes 20 per unit area at the right end position or the left end position that is proximate to the end of the pillar duct 12, 13 is smaller than that at the middle portion that is farther from the end of the pillar ducts 12, 13.

When the rear air conditioner unit 11 is operated and the air outlet of the rear air conditioner unit 11 and the pillar ducts 12, 13 are opened by operating the air blow mode switching devices, the conditioning air (cool air), a temperature of which is adjusted at a desired temperature in the rear air conditioner unit 11, is introduced into the air passage 17 through the pillar ducts 12, 13. Further, the air is blown downwardly from the holes 20, so the passenger compartment is air-conditioned.

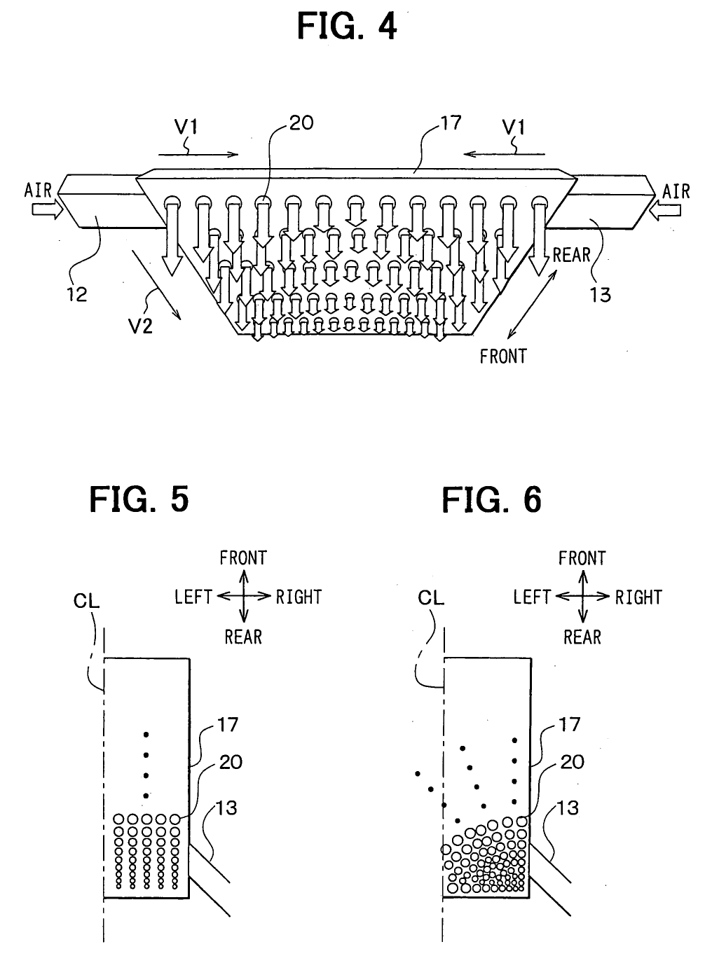

Here, the advantage of the first embodiment will be described as comparing with a comparison example shown in FIG. 4. In FIG. 4, the area of the openings of the holes 20 is uniform throughout the ceiling base member. Flow velocity of air blown from each hole 20 is represented by the length of an arrow.

Generally, pressure of air in the air passage 17 is high at positions proximate to the ends of the pillar ducts 12, 13. The pressure of air gradually reduces in the air passage 17 with the distance from the ends of the pillar ducts 12, 13 due to pressure loss resulting from a form of the air passage 17.

In FIG. 4, since the area of the openings of the holes 20 is uniform, the flow velocity of air from the holes 20 at positions that are proximate to the ends of the pillar ducts 12, 13, that is, at positions where the pressure of air is high, is high. As the pressure of air in the air passage 17 reduces with the distance from the ends of the pillar ducts 12, 13, the flow velocity of the air from each hole 20 reduces.

Therefore, as represented by the plural arrows in FIG. 4, the flow velocity of the air of each hole 20 reduces from the right and left end positions toward the middle position as shown by arrows V1. Also, the flow velocity reduces from the rear position toward the front position as shown by an arrow V2. Accordingly, in the comparison example, the flow velocity of the air from the holes 20 varies with respect to both of the right and left direction and the front and rear direction of the ceiling. As a result, it is difficult to provide uniform air-conditioning that the passenger feels comfortable.

On the other hand, in the first embodiment, the area of the opening of each hole 20 increases with its direction from the right and left end portions of the ceiling base member 19 that are proximate to the ends of the pillar duct 12, 13 toward the longitudinal axis CL. Accordingly, as compared with the example of FIG. 4, since the volume of air passing through each hole 20 at the positions proximate to the right and left end portions is reduced, the velocity of air of the holes 20 at those positions is reduced. On the other hand, in the middle position that is farther from the right and left end portion of the ceiling base member 19, since the volume of air passing through each hole 20 is increased, the flow velocity is increased. As a result, the flow velocity is uniformed with respect to the right and left direction of the ceiling.

Accordingly, the air, the flow velocity of which is relatively low, is uniformly blown from the holes 20, which are formed in the wide region of the ceiling base member 19, to enfold an upper half body of the passenger. Therefore, it is possible to provide a mild air-conditioning that the passenger feels comfortable.

Next, specific arrangement of the holes 20 will be described. In the case that the shape of the hole 20 is circle, a diameter φ of each hole 20 is approximately between 1.0 mm and 10 mm. The area of each hole 20 is approximately between 0.78 mm² and 78 mm². An opening rate of the holes 20, which is a ratio of the total area of the openings of the holes 20 to the area of the ceiling base member 19 corresponding to the air passage 17, is equal to or greater than 4%. A ventilation rate by the holes 20 is equal to or greater than 100 mL/cm²·s. Preferably, the rate is equal to or greater than 140 mL/cm²·s. This arrangement further improves the air-conditioning effect.

### Second Embodiment

Referring FIG. 5, the size of the holes 20 is varied with respect to the front and rear direction of the ceiling in the second embodiment. That is, the area of the openings of the holes 20 at a rear position that is proximate to the end of the pillar ducts 12, 13 is small. The area of the opening of each hole 20 increases toward the front position of the ceiling.

Accordingly, the volume of air passing through the holes 20 at the rear position is reduced by reducing the area of the openings. Also, the volume of air passing through the hole 20 is increased with a distance from the rear position by increasing the area of the openings. Therefore, the flow velocity of air is uniformed with respect to the front and rear direction of the ceiling.

### Third Embodiment

Referring FIG. 6, the area of the openings of the holes 20 is varied with respect to both of the front and rear direction and the right and left direction of the ceiling in the third embodiment. The area of the opening of the hole 20 that is located proximate to the right/left end and the rear end of the ceiling is the smallest. The area of the opening of the hole 20 is gradually increased toward the middle position CL and the front position of the ceiling. Accordingly, the flow velocity of the air passing through the holes 20 is uniformed with respect to the front and rear direction and the right and left direction of the ceiling.

### Fourth Embodiment

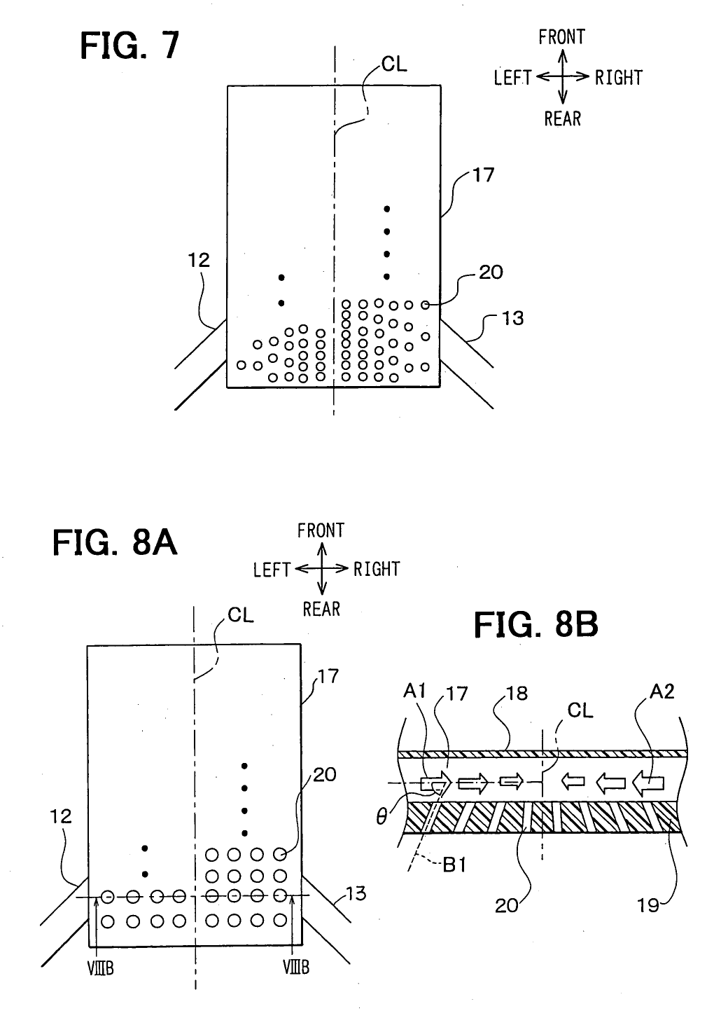

In the fourth embodiment, the area of the openings of the holes 20 is uniform. Instead the number of the holes 20 per unit area is varied. Specifically, as shown in FIG. 7, the number of the holes 20 per unit area is small at the right/left end position that is proximate to the end of the pillar duct 12, 13. The number of the holes 20 per unit area is increased toward the longitudinal axis CL.

Therefore, the total area of the openings of the holes 20 per unit area at the position that is proximate to the end of the pillar duct 12, 13 is smaller than that at a position further from the ends of the pillar ducts 12, 13. Accordingly, since the total area of the openings of the holes 20 per unit area gradually increases from the right and left end portions toward the middle position CL, the flow velocity per unit area is uniformed with respect to the right and left direction of the ceiling.

Alternatively, in the fourth embodiment, the number of the holes 20 can be varied with respect to the front and rear direction of the ceiling, similar to the second embodiment shown in FIG. 5. Further, the number of the holes 20 can be varied with respect to both of the front and rear direction and the right and left direction of the ceiling, similar to the third embodiment shown in FIG. 6.

### Fifth Embodiment

In the fifth embodiment, the area of the openings of the holes 20 is uniform as shown in FIG. 8A. The holes 20 are formed such that the opening direction of the holes 20, that is, the direction of the axes of the holes 20, is varied, as shown in FIG. 8B. Although not illustrated in FIG. 8B, the ends of the pillar ducts 12, 13 connect to the left end and the right end of the ceiling portion, respectively, so that the air flows through the air passage 17 as denoted by arrows A1 and A2.

The holes 20 are formed such that a flow resistance of the air reduces in the flow direction A1, A2 of the air passage 17. Specifically, in the flow direction A1, A2, an axis B1 of each succeeding hole 20 creates an increasingly larger angle θ with the air passage 17. That is, at the positions close to the ends of the pillar ducts 12, 13, the axis B1 of the hole 20 creates an acute angle with the flow direction A1, A2 so that the flow resistance is large. The angle θ gradually increases with the distance from the end of the pillar duct 12, 13 so that the flow resistance gradually reduces.

Especially in FIG. 8B, the holes 20 are formed such that the axis of succeeding hole 20 creates the increasingly larger acute angle θ up to the longitudinal axis CL of the ceiling. The angle θ of the hole 20 that is proximate to the right and left end position of the ceiling is smaller than that of the hole 20 that is proximate to the longitudinal axis CL.

Although the area of the openings of the holes 20 is uniform, the air flow resistance is changed by varying the opening direction of the holes 20, that is, by varying the inclination angle of the axis B1 of the holes 20. Therefore, the flow velocity is uniformed.

In addition, the holes 20 can be formed such that the angle θ between the axis B1 of the hole 20 and the flow direction of the air passage 17 is varied with respect to the front and rear direction of the ceiling. By this, the flow velocity is uniformed with respect to the front and rear direction of the ceiling. Further, the holes 20 can be formed such that the angle θ is varied with respect to both of the front and rear direction and the right and left direction of the ceiling.

### Sixth Embodiment

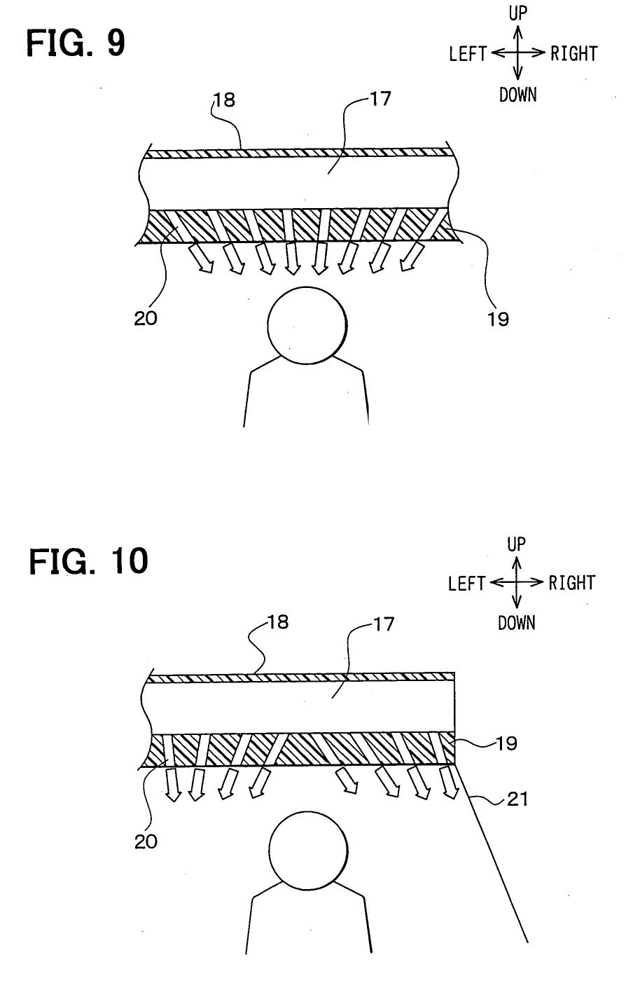

Referring to FIG. 9, in the sixth embodiment, the holes 20 are formed such that the opening direction of the holes 20, that is, the flow directions of the air from the holes 20, are concentrated toward the passenger head. Accordingly, the air (cool air) blown from the holes 20 concentrates to the passenger head. By this construction, the passenger can feel cool immediately. Further, this construction improves consciousness of the passenger by the cool air. Also in this case, the air is blown from the holes 20 that are formed in the wide range at low velocity, thereby improving the air-conditioning that the passenger feels comfortable.

### Seventh Embodiment

Referring FIG. 10, in the seventh embodiment, the holes 20 are formed such that the air blowing from the holes 20 flows along side windows 21 separately from a passenger head region. Since the air flows along the side windows 21, it is less likely that the passenger will feel hot due to radiant heat from the side windows 21, during the cooling operation. Accordingly, it improves the air-conditioning that the passenger feels comfortable cool feeling. Further, a volume of air that is directly blown toward the passenger head is reduced. Accordingly, it reduces passenger's discomfort due to the direct air flow.

Although only the right side window 21 is illustrated in FIG. 10, the similar structure is employed to the left side of the vehicle. Further, the holes 20 can be formed such that the air blowing from the holes 20 flows along the rear window and a windshield.

Further, a switching door can be provided in the air passage 17 such that a side region adjacent to the side window within the air passage 17 is separated by the door. By this, the air from the pillar ducts 12, 13 can be introduced only into the side region. Especially, in the heating operation in the cold climate, the warm air from the pillar ducts 12, 13 can be introduced into the side regions adjacent to the side windows 21 within the air passage 17 by switching the door. The warm air is blown toward the side windows 21 from the holes 20 corresponding to the side regions. This construction improves defrosting of the side windows 21.

### Eighth Embodiment

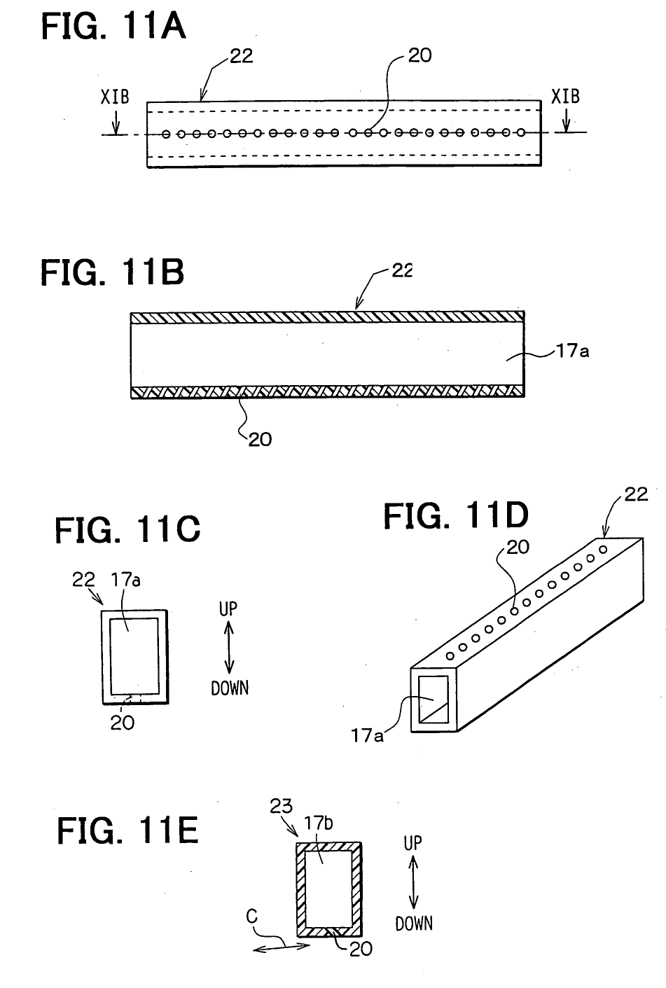

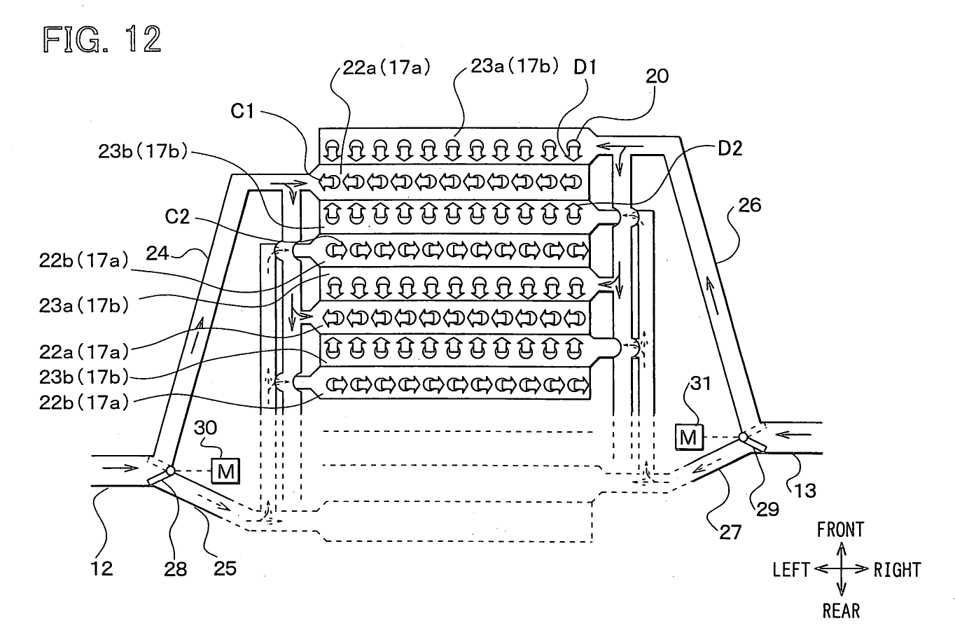

Referring to FIGS. 11A through 11E and 12, in the eighth embodiment, the holes 20 are provided such that the direction of the air blown from the holes 20 are variable in the four directions, that is, the right, left, front, and rear directions of the vehicle. In the first through seventh embodiments, the air passage 17 is defined between the ceiling base member 19 and the heat insulation sheet member 18 as a single passage. In the eighth embodiment, on the other hand, the air passage 17 is constructed by independent first air passages 17a and second air passages 17b.

Specifically, the air passages 17a, 17b are formed by separate first ceiling ducts (wall member) 22 and second ceiling ducts (wall member) 23. FIGS. 11A through 11D show the first ceiling ducts 22 and FIG. 11E shows the second ceiling duct 23. The first ceiling duct 22 and the second ceiling duct 23 have similar shape except the difference of the opening directions of the holes 20.

The ceiling ducts 22, 23 are made of a resin material. The ceiling ducts 22, 23 have tubular-shapes having rectangular-shaped cross-sections. The length of the ceiling ducts 22, 23 is slightly shorter than a width of the ceiling in the right and left direction. The holes 20 are formed on surfaces of the ducts 22, 23 that faces down in a condition that the ducts 22, 23 are arranged on the ceiling. The holes 20 are arranged in line along the longitudinal direction of the duct 22, 23.

The area of the openings of the holes 20 are uniform both in the first ceiling duct 22 and the second ceiling duct 23. The opening direction of the holes 20 of the first duct 22 is different from that of the second duct 23. Specifically, as shown in FIG. 11A, the holes 20 of the first ceiling duct 22 are formed such that the axes of the holes 20 are uniformly inclined with respect to the right and left direction of the ceiling, that is, the longitudinal direction of the first ceiling duct 22. As shown in FIG. 1E, on the other hand, the holes 20 of the second ceiling duct 23 are formed such that the axes of the holes 20 are inclined with respect to the front and rear direction (arrow C) of the ceiling, that is, the direction perpendicular to the longitudinal direction of the second duct 23.

The first ceiling ducts 22 and the second ceiling ducts 23 are arranged along the ceiling, as shown in FIG. 12. In FIG. 12, the first ducts 22 are denoted by numerals 22a and 22b because of the difference of the air flow directions. Similarly, the second ducts 23 are denoted by numerals 23a and 23b because of the difference of the air flow directions.

The first ducts 22a, 22b and the second ducts 23a, 23b are respectively alternately arranged with respect to the front and rear direction of the ceiling. Specifically, since the first ceiling ducts 22a, 22b are arranged alternately in the front and rear direction such that the axes of the holes 20 are inclined alternately opposite directions with respect to the right and left direction of the ceiling. Thus, the air is blown from the holes 20 of the first ceiling ducts 22 alternately opposite directions, as denoted by arrows C1, C2. In FIG. 12, the first ceiling ducts that are arranged such that the flow of air from the holes 20 are directed to the left side (arrow C1) of the vehicle are denoted by numerals 22a. The first ceiling ducts that are arranged such that the flow of air from the holes 20 are directed to the right side (arrow C2) of the vehicle are denoted by numerals 22b.

Similarly, the second ducts 23a,23b are alternately arranged such that the axes of the holes 20 are inclined alternately opposite direction with respect to the front and rear direction of the ceiling. Thus, the air is blown from the holes 20 of the second ceiling ducts 23 alternately opposite direction, as denoted by arrows D1, D2. In FIG. 12, the second ceiling ducts that are arranged such that the flow of air from the holes 20 are directed to the rear side (arrow D1) of the vehicle are denoted by numerals 23a. The second ducts that are arranged such that the flow of air from the holes 20 are directed to the front side (arrow D2) of the vehicle are denoted by numerals 23b.

Further, the left pillar duct 12 is divided into a first branched duct 24 and a second branched duct 25. The right pillar duct 13 is divided into a third branched duct 26 and a fourth branched duct 27. The branched duct 24 through 27 are arranged along the ceiling of the vehicle. The first branched duct 24 connects to the first ceiling ducts 22a that are arranged such that the air is blown to the left side (C1) to communicate with the air passages 17a formed in the first ceiling ducts 22a. The second branched duct 25 connects to the first ducts 22b that are arranged such that the air is blown to the right side (C2) to communicate with the air passages 17a formed in the first ceiling ducts 22b.

The third branched duct 26 connects to the second ceiling ducts 23a that are arranged such that the air is blown to the rear side (D1) and communicates with the air passages 17b formed in the second ceiling ducts 23a. The fourth branched duct 27 connects to the second ceiling ducts 23a that are arranged such that the air is blown to the front side (D2) and communicates with the air passages 17b formed in the second ceiling ducts 23b.

Further, a left air-distributing door 28 is arranged at the left branched point of the first and the second branched duct 24, 25 and the left pillar duct 12. Also, a right air-distributing door 29 is arranged at the right branched point of the third and fourth branched duct 26, 27 and the right pillar duct 13. The doors 28, 29 are in form of plates and rotatably supported, thereby providing air-distributing means. The doors 28, 29 are rotated by door-driving devices 30, 31. The door-driving devices 30, 31 provide actuating means for actuating the doors 28, 29. The door-driving devices 30, 31 receive power supply from an air conditioner controlling device (not shown).

Next, operation of the eighth embodiment will be described. In a condition shown in FIG. 12, the left air-distributing door 28 opens the first branched duct 24 and closes the second branched duct 25. Also, the right air-distributing door 29 opens the third branched duct 26 and closes the fourth branched duct 27. In this condition, therefore, the air flowing through the left pillar duct 12 is introduced into the air passages 17a of the first ceiling ducts 22a through the first branched duct 24. Further, the air flowing through the right pillar duct 13 is introduced into the air passages 17b of the second ceiling ducts 23a through the third branched duct 26.

Further, the air is blown from the holes 20 of the first ceiling ducts 22a to the left side of the vehicle as shown by the arrows C1. At the same time, the air is blown from the holes 20 of the second ceiling ducts 23a to the rear side of the vehicle as shown by the arrows D1.

Next, when the left air-distributing door 28 is moved by the door-driving device 30 to a position illustrated by dashed-line in FIG. 12 so that the door 28 closes the first branched duct 24 and opens the second branched duct 25, the air is introduced into the air passages 17a of the first ceiling ducts 22b through the second branched duct 25. The air is blown from the holes 20 toward the right side of the vehicle as shown by the arrows C2.

When the right air-distributing door 29 is moved by the door-driving device 31 to a position shown by dashed-line in FIG. 12 so that the third branched duct 26 is closed and the fourth branched duct 27 is opened, the air is introduced into the air passages 17b of the second ceiling ducts 23b from the fourth branched duct 27. The air is blown from the holes 20 to the front side of the vehicle as shown by the arrows D2.

Accordingly, by opening and closing the first to fourth branched ducts 24 to 27 by rotation of the doors 28, 29, the directions of the air blowing from the holes 20 are easily changed in four directions. Further, because the opening and closing of the doors 28, 29 are automatically switched by the air conditioner controlling device at predetermined time intervals, the air flow directions from the holes 20 can be automatically changed. In this way, the eighth embodiment provides an automatic switching operation (swing operation) for automatically switching the air flow directions.

In the eighth embodiment, the air flow directions are changeable with respect to the four directions, that is, the front, rear, right and left directions. However, the ducts 22, 23 can be arranged such that the air flow direction can be changed with respect to either the front and rear direction of the vehicle or with respect to the right and left direction of the vehicle.

Further, in the eighth embodiment, the arrangement of the holes 20 of the sixth and seventh embodiments can be employed. For example, the first ceiling duct 22 has the hole arrangement of the sixth embodiment and the second ceiling duct 23 has the hole arrangement of the seventh embodiment.

### Other Embodiments

Instead of the air from the rear air conditioner unit 11, the air from the front air conditioner unit 10 can be introduced into the air passages 17, 17a, 17b and blown into the passenger compartment from the holes 20. In this case, the pillar ducts, which corresponds to the left and the right pillar ducts 12, 13, are arranged along the front pillars 14 and connected to the air passages 17, 17a, 17b.

Further, the air outlet of the front air conditioner unit 10 and the air outlet of the rear air conditioner unit 11 can be communicated with the air passages 17, 17a, 17b through the pillar ducts. The air from the front air conditioner unit 10 and the air from the rear air conditioner unit 11 can be introduced into the air passages 17, 17a, 17b at the same time.

The present invention should not be limited to the disclosed embodiments, but may be implemented in other ways without departing from the spirit of the invention.

What is claimed is:

1. A ceiling air-blowing device for a vehicle air conditioner that has an air conditioner unit for air-conditioning a compartment of a vehicle, the device comprising:
a duct through which air from the air conditioner unit flows; and
a ceiling wall disposed along a ceiling portion of the vehicle to define an air passage communicating with an end of the duct for receiving the air,
wherein the ceiling wall is formed with a plurality of holes, and openings of the holes are defined on a lower surface of the ceiling wall so that the air flowing through the air passage is blown off into the compartment through the holes,
wherein the holes are disposed such that a total area of the openings of the holes per unit area at a first position that is proximate to the end of the duct is smaller than that at a second position that is farther from the end of the duct than the first position.

2. The device according to claim 1, wherein the holes are formed such that the area of each opening increases with its distance from the end of the duct.

3. The device according to claim 2, wherein the holes are formed such that the area of each opening varies with respect to a transverse direction of the ceiling wall.

4. The device according to claim 2, wherein the holes are formed such that the area of each opening varies with respect to a longitudinal direction of the ceiling wall.

5. The device according to claim 2, wherein the holes are formed such that the area of each opening varies with respect to longitudinal and transverse directions of the ceiling wall.

6. The device according to claim 1, wherein the holes are formed such that the number of holes at the first position is smaller than that at the second position.

7. The device according to claim 1, wherein the duct is arranged to extend along a pillar of the vehicle.

8. A ceiling air-blowing device for a vehicle air conditioner that has an air conditioner unit for air-conditioning a compartment of a vehicle, the device comprising:
a duct communicating with the air conditioner unit; and
a ceiling wall disposed along a ceiling portion of the vehicle to define an air passage communicating with an end of the duct for receiving the air,
wherein the ceiling wall is formed with a plurality of holes, and openings of the holes are defined on a lower surface of the ceiling wall so that the air flowing through the air passage is blown off into the compartment through the holes,
wherein the holes are formed so that an axis of each hole is disposed such that a flow resistance of air decreases with a distance from the end of the duct.

9. The device according to claim 8, wherein the holes are formed such that in a flow direction of the air passage, the axis of each succeeding hole creates an increasingly larger angle with the air passage.

10. The device according to claim 8, wherein the holes are formed such that in a flow direction of the air passage, the axis of each succeeding hole creates an increasingly larger acute angle with the air passage up to a longitudinal axis of the ceiling wall.

11. A ceiling air-blowing device for a vehicle air conditioner that has an air conditioning unit for air-conditioning a compartment of a vehicle, the device comprising:
an air passage member disposed along a ceiling portion of the vehicle, the air passage member including a first wall member defining a first air passage therein and a second wall member defining a second air passage therein; and
an air-distributing means for switching air distribution to the first passage and the second passage,
wherein the first wall member and the second wall member form a plurality of holes through which air in the first air passage and the second air passage is blown off into the compartment,
wherein the holes are formed such that an axis of each hole of the first wall member and an axis of each hole of the second wall member are inclined in different directions from each other.

12. The device according to claim 11, further comprising:
an actuating means for actuating the air-distributing means.

13. The device according to claim 11, wherein the holes are formed such that the axes of the holes of the first wall member and the axes of the holes of the second wall member are inclined in opposite directions from each other with respect to a longitudinal direction of the ceiling portion.

14. The device according to claim 11, wherein the holes are formed such that the axes of the holes of the first wall member and the axes of the holes of the second wall member are inclined in opposite directions from each other with respect to a transverse direction of the ceiling portion.

15. The device according to claim 11,
wherein the air passage member further includes a third wall member and a fourth wall member each defining an air passage therein through which the air from the air conditioner unit flows, and the third wall member and the fourth wall member form a plurality of holes through which the air is blown off into the passenger compartment,
wherein the holes are formed such that the axes of the holes of the first through fourth wall members are inclined in different directions from one another.

16. The device according to claim 11, further comprising:
a duct through which air from the air conditioner unit flows, wherein the duct is branched into a first branched duct connecting to the first air passage and a second branched duct connecting to the second air passage, and the air-distributing means is disposed at a branched point of the duct.
